(19) United States
(12) Patent Application Publication
(10) Pub. No.: US 2002/0168881 A1
(43) Pub. Date: Nov. 14, 2002

(54) Omnidirectionally adjustable wall lamp plug

(76) Inventors: Cun-Yu Hwang, Chang-Hua City (TW); Li-Hong Zheng, Chang-Hua City (TW)

Correspondence Address: DOUGHERTY & ROXELL, SUITE 1404, 5205 LEESBURG PIKE, FALLS CHURCH, VA, 22041, US

(21) Appl. No.: 09/852,640

(22) Filed: May 11, 2001

(51) Int. Cl. H01R 39/00

(52) U.S. Cl. 439/11

(57) ABSTRACT

An omnidirectionally adjustable wall lamp plug, wherein a conductor element having at its lateral end a vertical surface formed by bending and a contact element having at its lateral end a vertical side formed by bending are inserted into the wall lamp body. The union end of one prong in the plug base is against and in continuity with the vertical surface of the conductor element, with a retaining edge along each of the two sides of the union end enslotted in the plug base, and a connection washer end formed by bending at one extremity of a small-ended prong is situated against the vertical surface of the conductor element. As such, when the wall lamp of the present invention is rotated 360 degrees, the supply of electric current is maintained to achieve omnidirectional adjustment while the wall lamp is operating.

### BACKGROUND OF THE INVENTION

1) Field of the Invention

The invention herein relates to an omnidirectionally adjustable wall lamp plug in which a conductor element and a contact element are inserted through the lead holes of the wall lamp body and, furthermore, the conductor element has formed by bending at its lateral end a vertical surface that is attached to the side of a press mount and the contact element has formed by bending at its lateral end a vertical side that is attached to a shaft of the press mount; the union end of a large-ended prong in a plug base is situated against and in continuity with the vertical surface of the conductor element and, furthermore, a retaining edge along each of its two sides of the union end are enslotted in the plug base and the connection washer end of a small-ended prong is situated against the vertical side of the contact element; as such, this provides for a wall lamp plug capable of 360-degree omnidirectional adjustment.

2) Description of the Prior Art

Referring to FIG. 1, a conventional wall lamp consists of a one-piece injection molded wall lamp body 10 and a plug base 101, with the wall lamp and the prongs 102 arranged at a fixed angle such that the wall lamp can only be plugged into a mains outlet either vertically or horizontally oriented and since the angle cannot be rotated, this precludes usage of both outlets and object placement at one side. As a result, numerous patents have been granted for adjustable angle wall lamp plug structures, including U.S. Pat. No. 6,093,028; 5,711,674; 5,352,122; 5,954,519; and 5,683.254. Although the said structures are capable of rotary angular adjustment, the structures are overly complex and difficult to assemble, resulting in the shortcomings of production cost and high malfunction rates.

### SUMMARY OF THE INVENTION

The primary objective of the invention herein is to provide an omnidirectionally adjustable wall lamp plug, wherein a conductor element and a contact element are inserted through the lead holes of the wall lamp body and, furthermore, the conductor element has formed by bending at its lateral end a vertical surface that is attached to the side of a press mount and the contact element has formed by bending at its lateral end a vertical side that is attached to a shaft of the press mount; the union end of a large-ended prong in the plug base is situated against and in continuity with the vertical surface of the conductor element and, furthermore, the retaining edge along each of its two sides of the union end are enslotted in the plug base and the connection washer end of a small-ended prong is situated against the vertical side of the contact element; as such, this provides a wall lamp plug capable of 360-degree omnidirectional adjustment of simplified structure and, furthermore, one that is easily assembled and low in production cost

### BRIEF DESCRIPTION OF THE DRAWINGS

FIG. 1 is an isometric drawing of a conventional wall lamp plug.

FIG. 2 is an exploded drawing of conventional rotating-type plug.

FIG. 3 is an exploded drawing of the invention herein.

FIG. 4 is an isometric drawing of the invention herein.

FIG. 5-A to 5-H are an orthographic drawing of the rotational wall lamp plug embodiment of the invention herein.

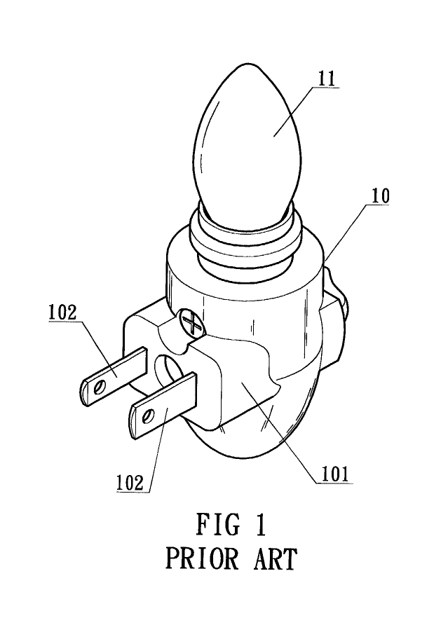

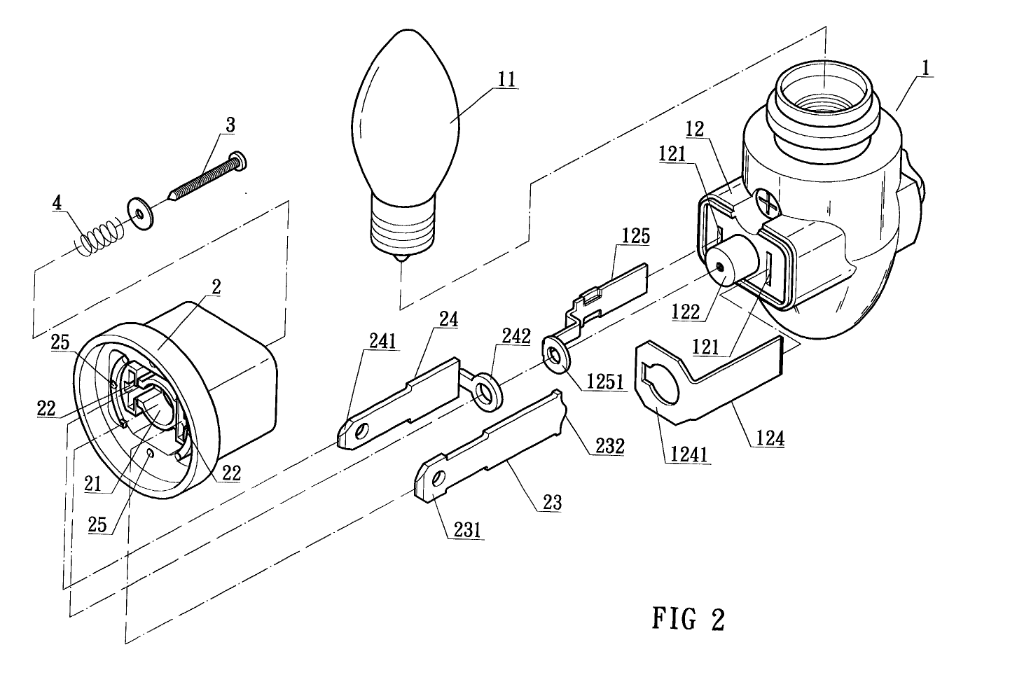

### DETAILED DESCRIPTION OF THE INVENTION

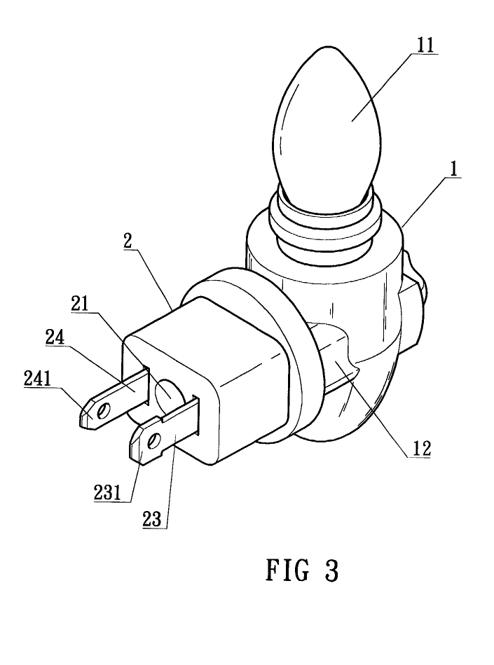

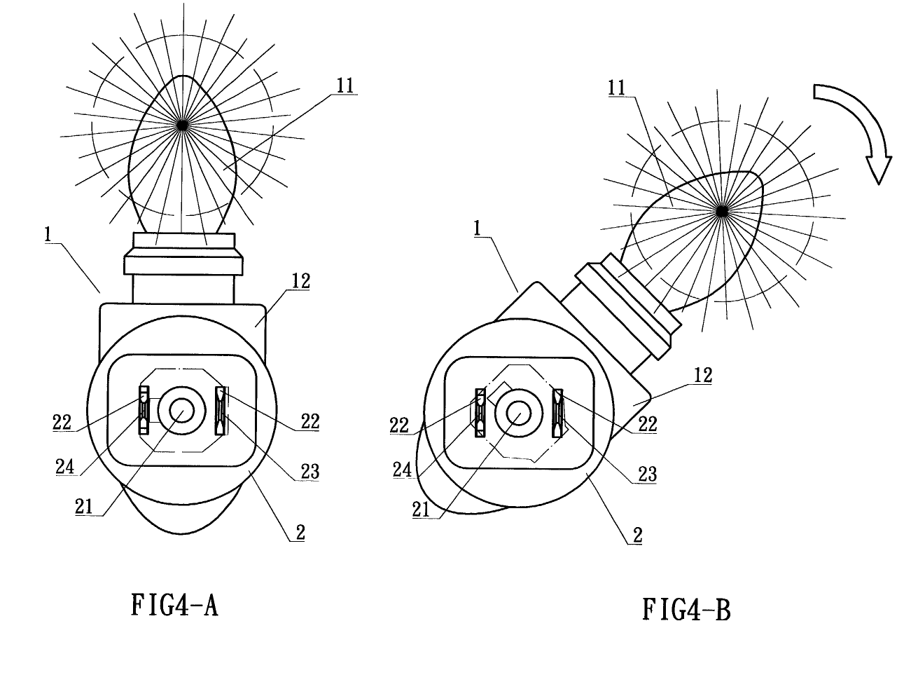

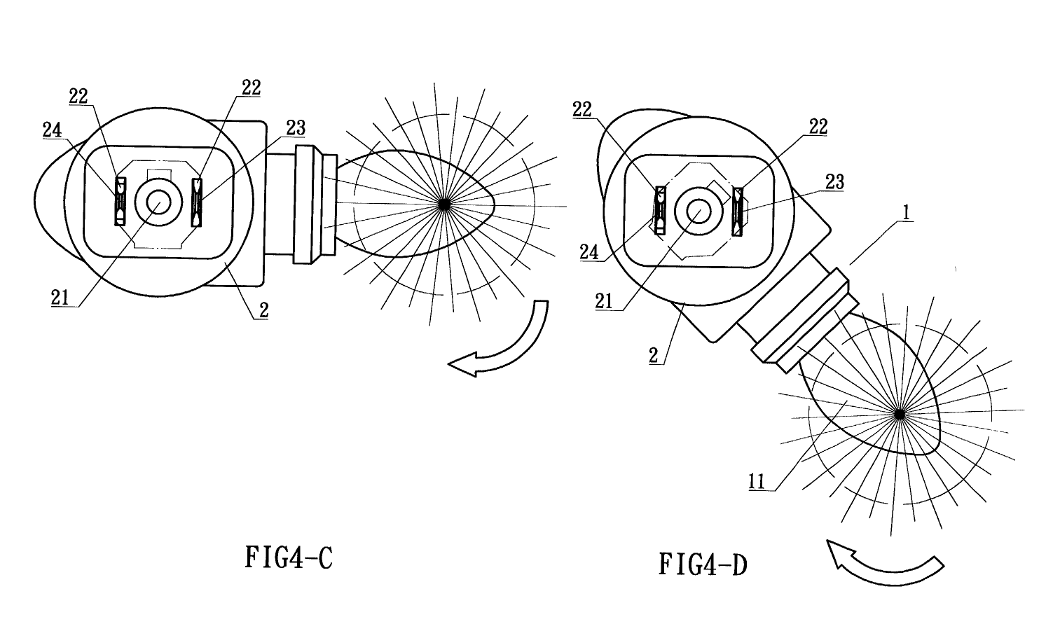

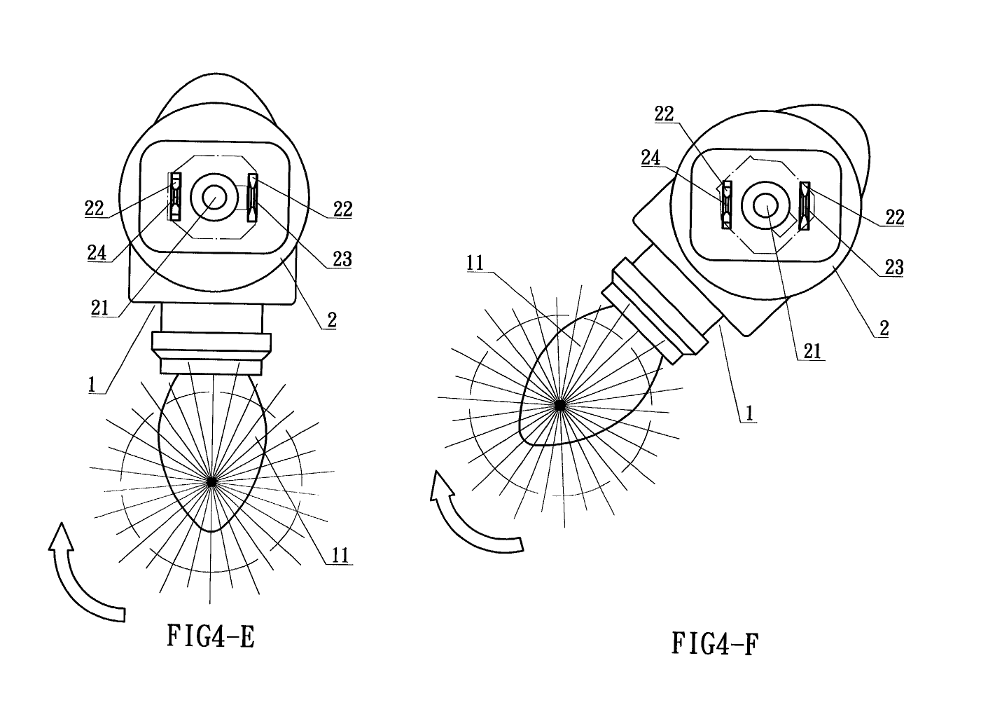

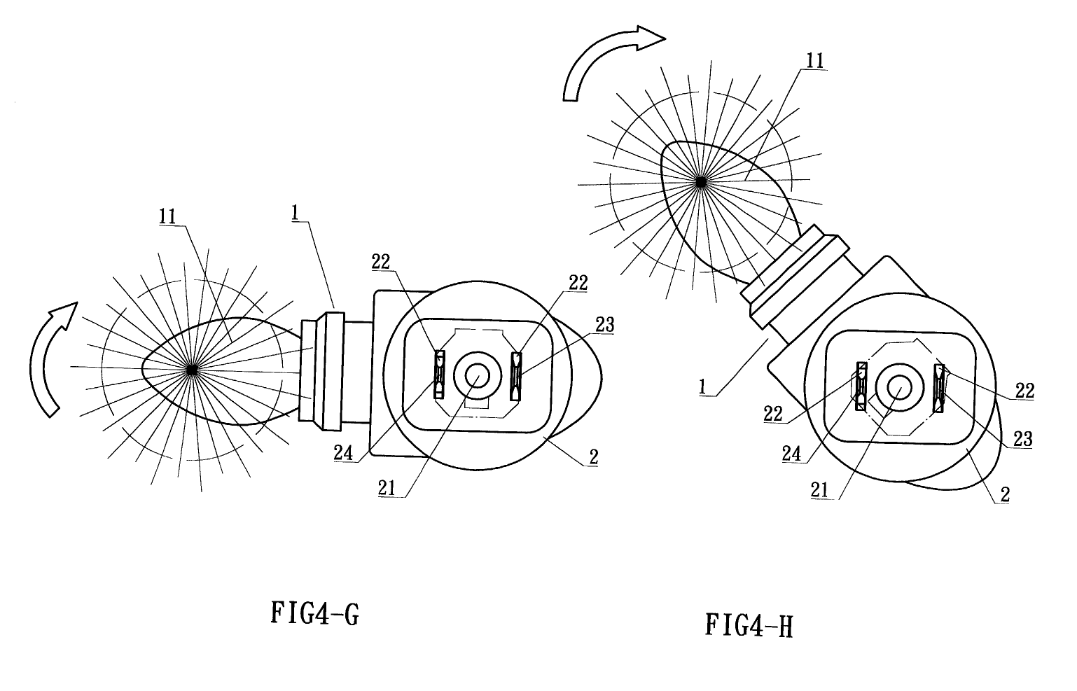

Referring to FIG. 3 and FIG. 4, the invention herein is comprised of a wall lamp body 1 having a light bulb 11 socketed at its top end, a plug base 2 attached to the lateral end of the body 1, as well as a screw 3 and a spring 4 that fastens the body 1 to the plug base 2, of which:

The said body 1 has a start switch A that toggles power from the mains source on and off installed in its lateral end, a press mount 12 with lead holes 121 protruding from the other end and, furthermore, a shaft 122 projects between the press mount 12 and the lead holes 121 and a locating post 123 is disposed at each of the two opposite corners of the press mount 12; and a conductor element 124 and a contact element 125 are respectively inserted through the lead holes 121 of the body 1.

The said conductor element 124 has formed by bending at its lateral end a vertical surface 1241 with a through-hole and, furthermore, after the conductor element 124 is inserted, its vertical surface 1241 is sleeved over the shaft 122 and against the side of the press mount 12.

The said contact element 125 has formed by bending at its lateral end a vertical side 1251 with a through-hole and, furthermore, after the contact element 125 is inserted, its vertical side 1251 is situated against the shaft 122.

The said plug base 2 has a fastening hole 21 at its center and, furthermore, a prong hole 22 is formed at each of the two sides of the fastening hole 21, and a large-ended and a small-ended prong 23 and 24 are respectively inserted into the said prong holes 22; at the opposing ends where the plug base 2 is fastened to the body 1, a plurality of locating recesses 25 are arrayed sequentially such that when the body 1 is rotated, the locating posts 123 on it are sequentially aligned with and engage the locating recesses 25 of the plug base 2, thereby achieving 360-degree rotation capability, of which:

The said large-ended prong 23 consists of an insertion end 231 at one extremity with the other extremity being of a slight convex shape and, furthermore, this union end 232 is situated against and in continuity with the vertical surface 1241 of the conductor element 124, the union end 232 having a retaining edge 233 along each of its two sides such that after the large-ended prong 23 is inserted, the retaining edges 233 are enslotted at the rear end margins of the prong hole 22, thereby enabling connectivity between the body 1 and the plug base 2.

The said small-ended prong 24 consists of an insertion end 241 at one extremity and a connection washer end 242 formed by bending at the other extremity that is situated against the vertical side 1251 of the contact element 125 and, furthermore, after the small-ended prong 24 is inserted, the connection washer 242 is situated against the inner side of the fastening hole 21.

Referring to FIG. 5-A, FIG. 5-B, FIG. 5-C, FIG. 5-D, FIG. 5-E, FIG. 5-F, FIG. 5-G, and FIG. 5-H, the screw is first inserted through the spring 4 and into the fastening hole 21 of the plug base 2 and then installed to the shaft 122 of the body 1 to fasten the body 1 and the plug base 2 into a single structural entity, with the elasticity of the spring 4 leaving clearance between the plug base 2 and the body 1 such that the body 1 fastening is not completely flush, thereby enabling the body 1 to rotate 360 degrees; as such, when the wall lamp is rotated, the union end 232 of the large-ended prong 23 is against the conductor element 124 of the body 1 and the connection washer end 242 of the small-ended prong 24 is against the contact element 125 of the body 1, thereby maintaining electrical continuity between the body 1 and the plug base 2; furthermore, the locating posts 123 of the body 1 are sequentially aligned and engaged into position in the locating recesses 25 of the plug base 2; as such, when the plug base 2 is inserted into a wall outlet, since the body 1 rotates on the shaft 122 at the center and becomes fixed at every position where locating posts 123 and locating recesses 25 are in alignment, the wall lamp of present invention is capable of rotation 360 degrees for omnidirectional adjustment to any desired angle while it is powered and, furthermore, is equipped with a start switch A to toggle power from the mains source on and off.

1. An omnidirectionally adjustable wall lamp plug comprised of a wall lamp body having a light bulb socketed at its top end and a start switch that toggles power from the mains source on and off installed in one lateral end, a plug base attached to the lateral end of the said body, as well as a screw and a spring that fastens the body to the said plug base, of which:
The said body has a press mount with lead holes protruding from its side and, furthermore, a shaft projects from the said press mount; a locating post is disposed at each of the two opposite corners of the said press mount; and a conductor element and a contact element are respectively inserted through the said lead holes.
The said plug base has a fastening hole and two prong holes and, furthermore, a large-ended and a small-ended prong are respectively inserted into the said prong holes; the union end of the said large-ended prong in the said plug base is situated against the said conductor element of the body and the connection washer end of the said small-ended prong is situated against the said contact element of the said body.
As such, the said conductor element of the said body and the said union end of the said plug base are in state of continuity while the said wall lamp is rotated 360 degrees and, furthermore, the said wall lamp is equipped with a start switch to toggle power from the mains source on and off.

2. As mentioned in claim 1 of the omnidirectionally adjustable wall lamp plug of the invention herein, the said body conductor element has formed by bending at its lateral end a vertical surface with a through-hole and, furthermore, the said vertical surface of the said conductor element is sleeved over the said shaft at the side of the said press mount; the said body contact element has formed by bending at its lateral end a vertical side with a through-hole and, furthermore, after the said contact element is inserted, the said vertical side is situated onto the said shaft.

3. As mentioned in claim 1 of the omnidirectionally adjustable wall lamp plug of the invention herein, the said union end at one extremity of the said large-ended prong in the said plug base is situated against and in continuity with the said vertical surface of the said conductor element, the said union end having a retaining edge along each of its two sides and, furthermore, after the said retaining edges along the said large-ended prong are inserted, they are enslotted in the rear end margins of the said prong hole; the said connection washer end formed by bending at one extremity of the said small-ended prong in the said plug base is situated against the said vertical side of the said contact element and, furthermore, after the said small-ended prong is inserted, the said connection washer is situated against the inner side of the said fastening hole.

4. As mentioned in claim 1 of the omnidirectionally adjustable wall lamp plug of the invention herein, the said press mount of the said body has a locating post disposed at each of its two opposite corners; at the opposing ends where the said plug base is fastened to the said body, a plurality of locating recesses are arrayed sequentially such that when the said body is rotated, the said locating posts on it are sequentially aligned with and engage the said locating recesses of the said plug base.
